(19) United States
(12) Patent Application Publication
(10) Pub. No.: US 2008/0010583 A1
(43) Pub. Date: Jan. 10, 2008

(54) Computer-readable medium storing markup documents, and method and apparatus of processing the markup documents

(75) Inventor: Hwa-kyung Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/657,477

(22) Filed: Jan. 25, 2007

(30) Foreign Application Priority Data
Jul. 4, 2006 (KR) 10-2006-0062439

(51) Int. Cl. G06F 17/00

(52) U.S. Cl. 715/200; 715/234; 715/273

(57) ABSTRACT

Provided are a computer-readable medium storing markup documents and having a structure in which a plurality of markup documents are output as an integrated document, and a method and an apparatus of processing the markup documents. The computer-readable medium includes a plurality of markup documents and order information indicating an order in which the plurality of markup documents are to be output. Therefore, by introducing a concept of an output order and a master page to a plurality of independent markup documents, it is possible to integrate and output the plurality of markup documents as a single page.

### CROSS-REFERENCE TO RELATED PATENT APPLICATION

This application claims the benefit of priority from Korean Patent Application No. 10-2006-0062439, filed on Jul. 4, 2006, in the Korean Intellectual Property Office, the disclosure of which is incorporated herein in its entirety by reference.

### BACKGROUND OF THE INVENTION

1. Field of the Invention

The present invention is consistent with methods and apparatuses that relate to a structure of a markup document, and more particularly, to a computer-readable medium storing markup documents and having a structure in which a plurality of markup documents are outputted as an integrated document, and a method and an apparatus of processing the markup documents.

2. Description of the Related Art

When content is represented using a markup document such as Hyper Text Markup Language (HTML), etc., a case when fixed data and variable data are output on the same screen or when several variable data are respectively integrated with single fixed data and the results are printed on several papers, can occur. When a markup document is output, fixed data is output as a background and variable data is output in a manner to be overlaid on the fixed data.

FIG. 1 illustrates an example in which fixed data and variable data are integrated and output on a screen. Referring to FIG. 1, fixed data 110 for representing a format of a schedule table and variable data 120 for representing an actual schedule are integrated and displayed as a web page 130. Several conventional methods for generating a markup document to obtain such an integrated web page 130 exist.

FIG. 2 is a view for explaining a conventional method for generating the web page 130 illustrated in FIG. 1.

Referring to FIG. 2, all content that is to be output is included in a markup document 210 without separating fixed data from variable data. The markup document 210 is input into and is processed by a user agent 220 of a web browser. The user agent 220 includes a markup content processor 222 for processing markup content, a background processor 224 for processing background images, and a cascading style sheet (CSS) processor 226 for processing CSS. In the technique of FIG. 2, a schedule table and actual schedule data are constructed as tags and text and are included in a body part. The markup content processor 222 interprets and processes the tags and text, and generates an output web page 230.

In the conventional method, since fixed data is included in a document represented by variable data, preparation of documents is difficult and readability of documents is poor.

FIG. 3 is a view for explaining another conventional method for generating the web page 130 illustrated in FIG. 1.

Referring to FIG. 3, fixed data is constructed as a background image 320, and variable data is constructed as text content in a markup document 310. The background processor 224 sets the background image 320 as a background of an entire document, and the markup content processor 222 overlays a web page 312 according to the markup document 310 on the background image 320 and thus generates an integrated web page 330.

In the conventional method, since fixed data is represented by an image, it is not easy to change the fixed data according to a condition.

FIG. 4 is a view for explaining another conventional method for generating the web page 130 illustrated in FIG. 1.

Referring to FIG. 4, fixed data 412 is described using CSS and variable data 414 including actual schedule data is described by tags and text, so that a markup document 410 is constructed. The fixed data 412 becomes a web page 422 including a schedule table by the CSS processor 226, and the variable data 414 is processed by the markup content processor 222 and becomes a web page 424 including actual schedule data. The web pages 422 and 424 are integrated and output as a web page 430.

In the conventional method, as in the conventional method described above with reference to FIG. 2, since fixed data is included and represented in a document including variable data, preparing of documents is difficult and readability of documents is poor.

### SUMMARY OF THE INVENTION

The present invention defines a markup document structure in which a plurality of independent markup documents are integrated and output into a markup document with an equal relation without a dependency relation, and provides a method and an apparatus for processing and outputting the markup document.

According to an aspect of the present invention, there is provided a computer-readable medium, including: a plurality of markup documents; and order information indicating an output order of the plurality of markup documents.

The computer-readable medium may further include a start document including access information for the plurality of markup documents. The order information is recorded in the start document.

The order information may include information indicating that one of the plurality of markup documents is a master document including fixed data that is to be printed as a background of a different markup document. The order information further includes information about an order in which the remaining markup documents except for the master document are overlaid and printed on the master document.

The order information includes information about an order in which the plurality of markup document are overlaid, when the plurality of markup documents are displayed as a web page.

The order information may be recorded in the plurality of markup documents.

One of the plurality of markup documents may be a background markup document that is to be output as a background of a different markup document that includes variable data, and the order information may include access information for the background markup document, and the access information for the background markup document may be recorded in the different markup document.

The computer-readable medium may further include one or more background markup documents, wherein the order information includes information about an order in which the one or more background markup documents are overlaid, when the plurality of markup documents are displayed.

The order information about the order in which the one or more background markup documents are overlaid may be recorded in the different markup document.

According to another aspect of the present invention, there is provided a computer-readable medium storing a markup document. The markup document includes: a plurality of body parts; and order information about an order in which the plurality of body parts are to be output.

The order information includes information about a master body that is to be printed as a background of different body parts, when the markup document is printed. The order information further includes information indicating an order in which the remaining body parts except for the master body part are overlaid and printed on the master body part.

The order information further includes information indicating an order in which the plurality of body parts are overlaid, when the markup document is displayed as a web page.

The order information is recorded in the respective body parts.

According to another aspect of the present invention, there is provided a method of processing a markup document, including: receiving a start document including access information for a plurality of markup documents; acquiring order information indicating an order in which the plurality of markup documents are output; receiving the plurality of markup documents according to the access information; and outputting the plurality of markup documents according to the order information.

The acquiring of the order information includes interpreting the start document and determining the output order.

The outputting of the plurality of markup documents includes: selecting one of the plurality of markup documents as a master document including fixed data, with reference to the order information; and controlling so that the remaining markup documents except for the master document are respectively overlaid on the master document and sequentially printed according to the order information.

The outputting of the plurality of markup documents includes: generating and outputting an image in which the plurality of markup documents are overlaid, according to the order information.

The acquiring of the order information includes interpreting the plurality of markup documents and determining the output order.

The acquiring of the order information includes determining the output order, according to a description order of access information recorded in the start document or according to an order in which the plurality of markup documents are received.

According to another aspect of the present invention, there is provided a method of processing a markup document, including: receiving a markup document including variable data and access information for at least one background markup document; receiving the at least one background markup document according to the access information; and overlaying the markup document including the variable data on the at least one background markup document and outputting the resultant markup document.

The overlaying of the markup document further includes determining an overlay order, with reference to information about an order in which the at least one background markup document is output.

The determining of the overlay order includes determining the overlay order according to order information included in the markup document including the variable data.

The determining of the overlay order includes determining the overlay order according to order information included in the at least one background markup document.

According to another aspect of the present invention, there is provided a method of processing and outputting a markup document, including: receiving a markup document including a plurality of body parts; acquiring order information about an output order in which the plurality of body parts are to be output; and controlling so that the plurality of body parts are overlaid and displayed or printed according to the order information.

The acquiring of the order information includes interpreting the respective body parts and determining the output order.

The acquiring of the order information comprises determining the output order according to an order in which the respective body parts are described in the markup document.

According to another aspect of the present invention, there is provided an apparatus including a processor for processing and outputting a markup document in order to display or print the markup document, wherein the processor comprises a markup content processor for receiving a start document including access information for a plurality of markup documents, acquiring order information indicating an output order in which the plurality of markup documents are outputted, receiving the plurality of markup documents according to the access information, and outputting the plurality of markup documents according to the order information.

According to another aspect of the present invention, there is provided an apparatus including a processor for processing and outputting a markup document in order to display or print the markup document, wherein the processor comprises a markup content processor for receiving a markup document including variable data and access information of at least one background markup document, receiving the at least one background markup document according to the access information, overlaying the markup document including the variable data on the at least one background markup document, and outputting the resultant markup document.

According to another aspect of the present invention, there is provided an apparatus including a processor for processing and outputting a markup document to display or print the markup document, wherein the processor comprises a markup content processor for receiving a markup document including a plurality of body parts, acquiring order information about an order in which the plurality of body parts are to be output, overlaying the plurality of body parts according to the order information, and controlling so that the plurality of body parts are displayed or printed.

### BRIEF DESCRIPTION OF THE DRAWINGS

The above and other features and aspects of the present invention will become more apparent by describing in detail exemplary embodiments thereof with reference to the attached drawings in which:

FIG. 1 illustrates an example of integrating and outputting fixed data and variable data as a web page;

FIG. 2 is a view for explaining a related art method for generating the web page illustrated in FIG. 1;

FIG. 3 is a view for explaining another related art method for generating the web page illustrated in FIG. 1;

FIG. 4 is a view for explaining another related art method for generating the web page illustrated in FIG. 1;

FIG. 5 is a block diagram of a markup document processing apparatus according to an exemplary embodiment of the present invention;

FIG. 6 is a view for explaining a computer-readable medium storing markup documents, according to an exemplary embodiment of the present invention;

FIG. 7 illustrates a start document according to an exemplary embodiment of the present invention;

FIG. 8 is a flowchart illustrating a markup document processing method according to an exemplary embodiment of the present invention;

FIG. 9 illustrates an example to which the markup document processing method illustrated in FIG. 8 is applied;

FIG. 10 is a view for explaining a computer-readable medium storing markup documents, according to another exemplary embodiment of the present invention;

FIGS. 11A and 11B illustrate examples in which access information of a background markup document according to an exemplary embodiment of the present invention is described;

FIG. 12 is a flowchart illustrating a markup document processing method according to another exemplary embodiment of the present invention;

FIG. 13 illustrates an example to which the markup document processing method illustrated in FIG. 12 is applied;

FIG. 14 is a view for explaining a computer-readable medium storing markup documents, according to another exemplary embodiment of the present invention; and

FIG. 15 is a flowchart illustrating a markup document processing method according to an exemplary embodiment of the present invention.

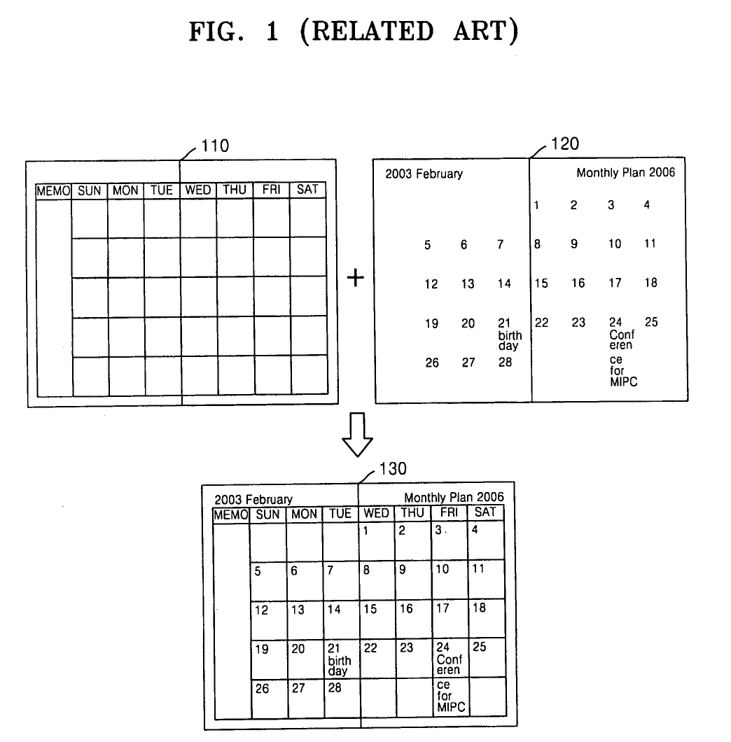

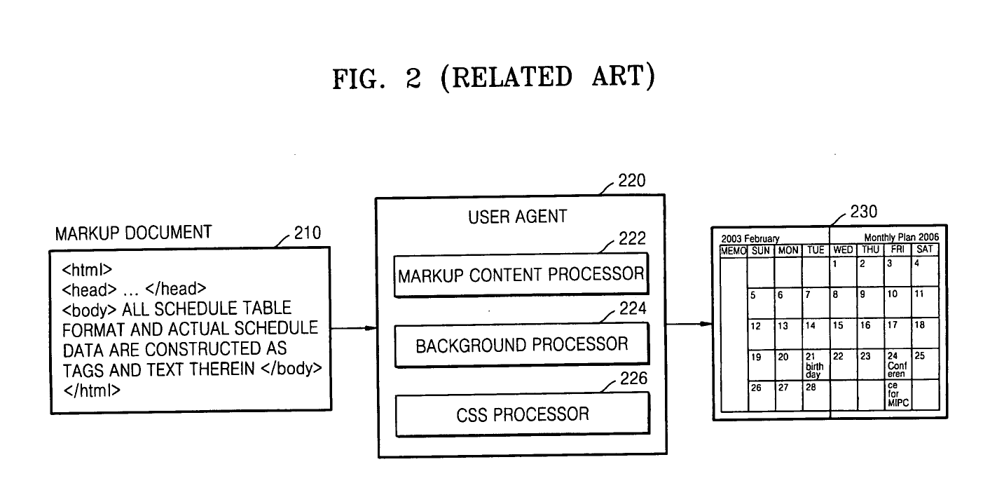

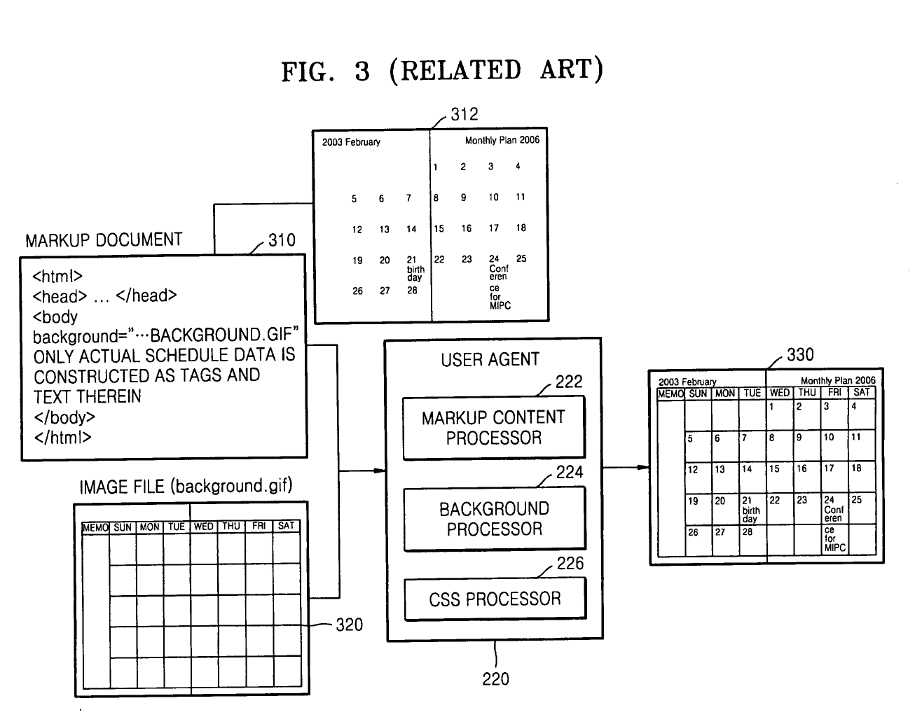

### DETAILED DESCRIPTION OF EXEMPLARY EMBODIMENTS OF THE PRESENT INVENTION

Hereinafter, exemplary embodiments of the present invention will be described with reference to the appended drawings.

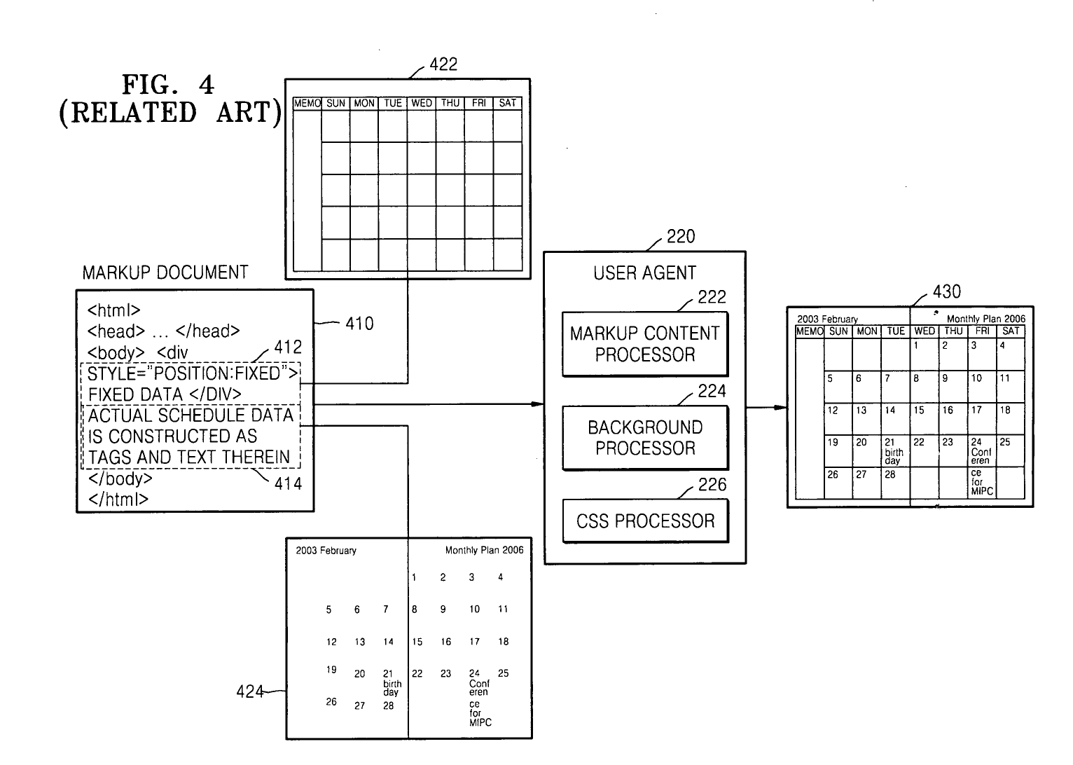

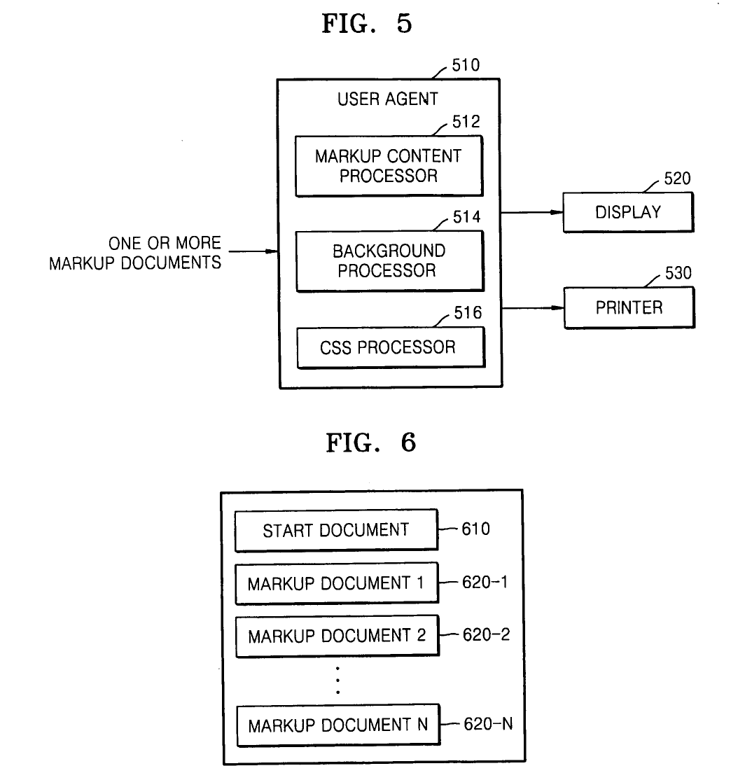

FIG. 5 is a block diagram of a markup document processing apparatus according to an exemplary embodiment of the present invention.

Referring to FIG. 5, a processor (not shown) of the markup document processing apparatus according to the exemplary embodiment of the present invention operates a web browser (not shown) according to the exemplary embodiment of the present invention. The web browser is constructed by improving a markup content processor 512 included in a user agent 510. The user agent 510 according to an exemplary embodiment of the present invention includes a new markup content processor 512 for processing markup documents with a structure according to an exemplary embodiment of the present invention, and can include a background processor 514 and a cascading style sheet (CSS) processor 516 such as the ones described in a conventional technique. One or more markup documents processed and/or integrated by the user agent 510 is output through a display 520 or a printer 530. The markup content processor 512 generates and outputs an image corresponding to an integrated document, or generates and outputs an integrated document with a format supported by the printer 530. An exemplary markup document processing method for generating the integrated document will be described later with reference to FIGS. 6 through 15.

FIG. 6 is a view for explaining an information recording medium storing markup documents, according to an exemplary embodiment of the present invention. The information recording medium may be a computer-readable medium. However, a computer-readable medium is provided by way of an example only and not by way of a limitation. The present invention may be embodied on various different information recording mediums.

Referring to FIG. 6, the computer-readable medium includes a plurality of markup documents 620-1 through 620-N and a start document 610 storing file names or path names that are access information of the markup documents 620-1 through 620-N, in order to output an integrated web page according to an exemplary embodiment of the present invention. Also, the computer-readable medium can include order information that represents an output order of the markup documents 620-1 through 620-N. The order information can include information about a master document including fixed data that is to be displayed or printed as a background of a different markup document, among the markup documents 620-1 through 620-N, and information about an order in which markup documents including arbitrary data except for the master document are overlaid on the master document. The order information can be included in the start document 610 or in the respective markup documents 620-1 through 620-N. In case when the order information is included in the respective markup documents 620-1 through 620-N, the order information can be described in a <html>tag (for example, <html style=“order:1”>) or in a <meta>tag (for example, <meta order=1. . . >). However, the present invention is not limited to these, and the order information can be described by various different methods.

According to another exemplary embodiment of the present invention, the computer-readable medium does not comprise a start document and the access path for the plurality of markup documents 620-1 through 620-N to be displayed or printed can be acquired by a different method. For example, if a <href= . . . > tag for linking a plurality of markup documents is newly defined, the markup content processor 512 receives the linked markup documents, and determines an output order of the markup documents, on the basis of order information described in the respective markup documents, a transfer order of the respective markup documents, or description contents or description orders included in the link tags of the respective markup documents.

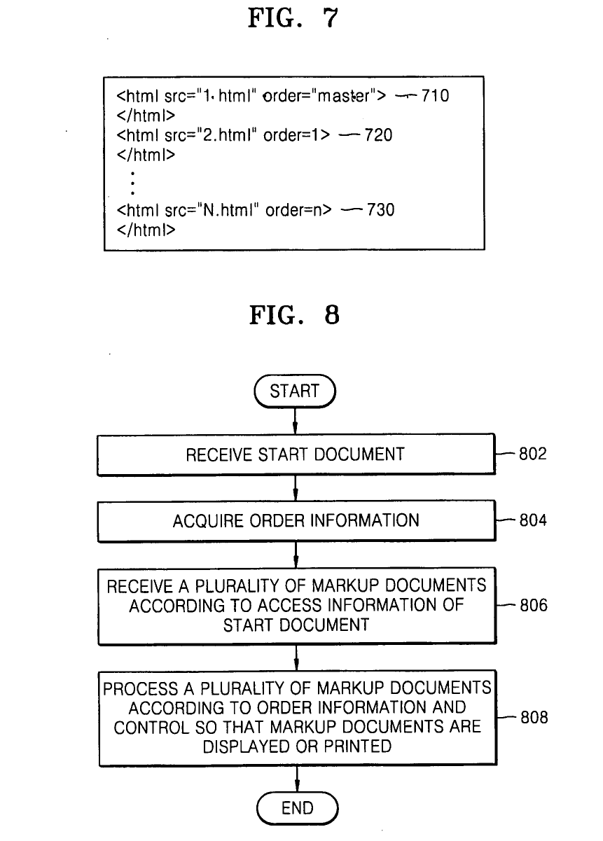

FIG. 7 illustrates a start document according to an exemplary embodiment of the present invention.

Referring to FIGS. 5 and 7, file names src for N markup documents from “1.html” to “N.html” and order information for the corresponding files are recorded in <html>tags 710, 720 and 730 of a start document. The markup document “1.html” is designated as a master document. Accordingly, the markup content processor 512 controls so that a screen in which the markup document “1.html” is displayed as the lowermost background and the markup documents “2.html” through “N.html” are overlaid in a predetermined order and are output on the display 520. Likewise, in case when the markup documents are output through the printer 530, it is possible to output an integrated web page. Also, the markup content processor 512 controls so that a document obtained by overlaying the markup document “2.html” onto the markup document “1.html” as a background is output, and then a document obtained by overlaying the markup document “3.html” onto the markup document “1.html” as a background, is output. The process is repeated until the markup document “N.html” is output using the markup document “1.html” as a background.

FIG. 8 illustrates a flowchart illustrating a markup document processing method according to an exemplary embodiment of the present invention. In the markup document processing method, the markup content processor 512 processes markup documents such as the ones depicted in FIG. 6.

Referring to FIGS. 5 and 8, first, the markup content processor 512 receives a start document (operation 802). Then, the markup content processor 512 interprets the start document and obtains access information and order information (operation 804). Successively, the markup content processor 512 receives a plurality of markup documents using the access information (operation 806). Then, the markup content processor 512 processes the plurality of markup documents according to the order information, and controls so that the plurality of markup documents are displayed or printed (operation 808). If the order information is not definitely described in the start document or the plurality of markup documents, order information must be determined. In this case, the markup content processor 512 can determine an output order of the markup documents according to a description order of access information described in a start document. For example, it is determined that a first markup document described in a start document is a master document, and the remaining markup documents except for the master document are output or overlaid in an order which the markup documents are described. Alternatively, the markup content processor 512 can determine that a first received markup document is a master document and the following received markup documents are output or overlaid in an order in which the markup documents are received. In case of an exemplary embodiment in which no start document is included, an output order can be determined with reference to order information described in respective markup documents or an order in which respective markup documents are received.

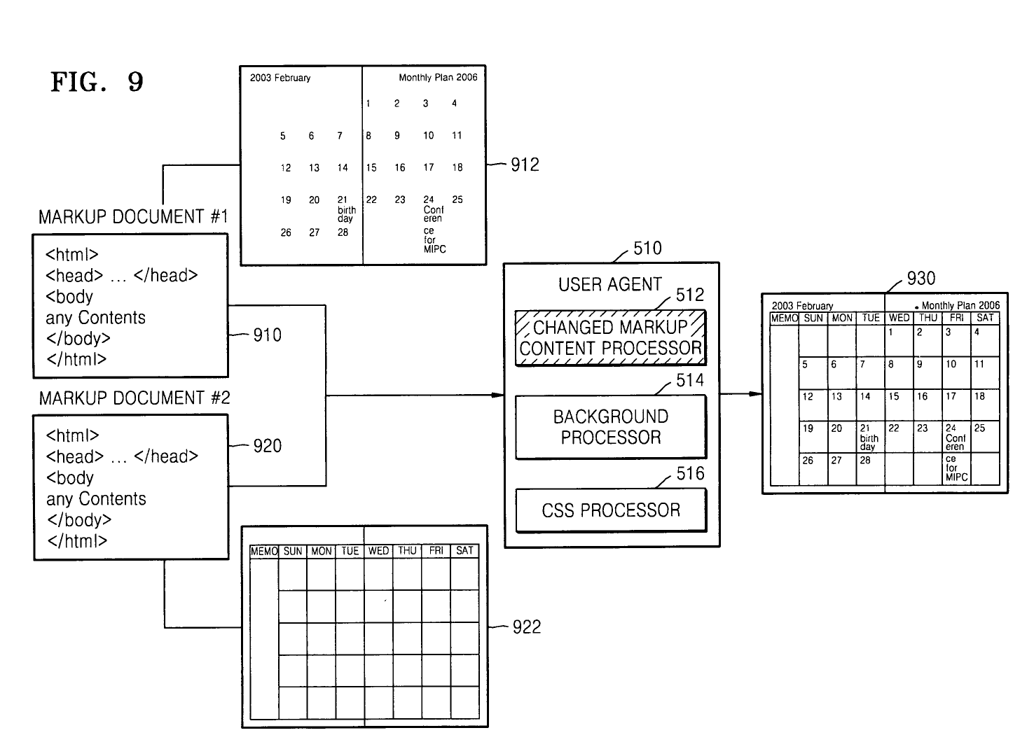

FIG. 9 illustrates an example to which the markup document processing method illustrated in FIG. 8 is applied.

Referring to FIG. 9, access information for a markup document #1 910 and a markup document #2 920 is recorded in a start document (not shown), and the markup document #1 910 and the markup document #2 920 are requested according to access information input into the markup content processor 512 (see FIG. 5) according to an exemplary embodiment of the present invention. The markup content processor 512 performs an operation of outputting a web page 930 in which a master document or a markup document #2 920 designated as a document having an output priority is used as a background 922 and a markup document #1 910 in which variable data is provided 912 is overlaid on the background 922.

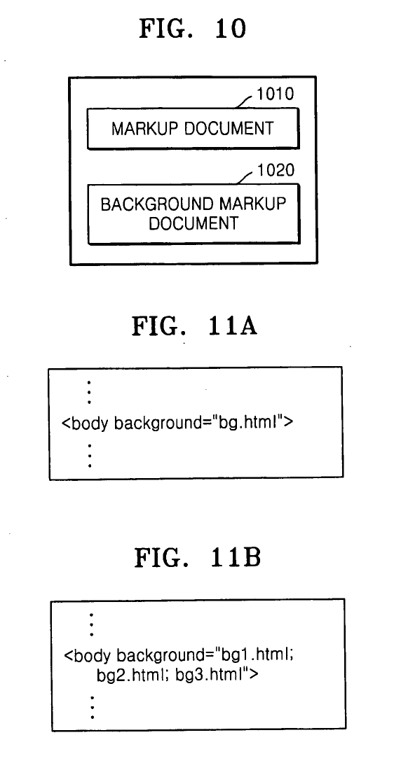

FIG. 10 is a view for explaining a computer-readable medium storing markup documents, according to another exemplary embodiment of the present invention.

Referring to FIG. 10, the computer-readable medium includes a markup document 1010 and a background markup document 1020 in order to output an integrated web page. Differently from conventional techniques, according to an exemplary embodiment of the present invention, markup documents can be used as background files. The markup document 1010 includes variable data and access information for the background markup document 1020. The markup content processor 512 uses fixed data included in the background markup document 1020 as a background, overlays the variable data of the markup document 1010 onto the background, and outputs the result. A plurality of background markup documents can be provided. In this case, variable data is overlaid on a background generated by overlaying the background markup documents with each other according to order information, so that an integrated web page is generated.

FIGS. 11A and 11B illustrate examples in which access information of a background markup document according to an exemplary embodiment of the present invention is described.

Referring to FIG. 11A, a path name of a background markup document is described in a <body> tag of a markup document including variable data. Referring to FIG. 11B, path names for a plurality of background markup documents can be described in a <body> tag of a markup document including variable data. In the <body> tag, information about an order in which the respective background markup documents are overlaid is further described, so that an output order is defined or an overlay order is determined according to an order in which the path names are described. Or, order information can be recorded in the respective background markup documents.

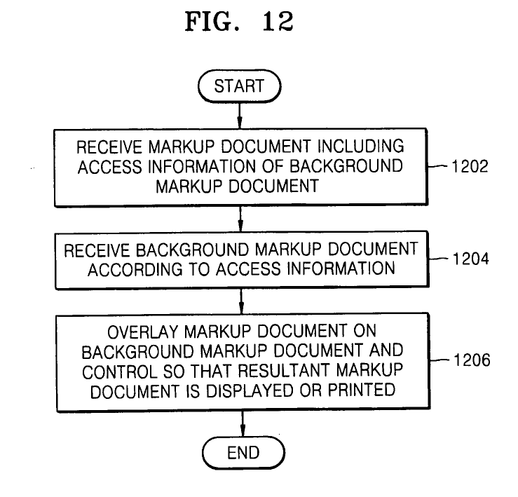

FIG. 12 is a flowchart illustrating a markup document processing method according to another exemplary embodiment of the present invention. In the markup document processing method, the markup content processor 512 processes markup documents constructed as illustrated in FIG. 10.

Referring to FIG. 12, a markup document including variable data is received (1202). The markup document includes access information and/or order information of at least one background markup document. Then, the at least one background markup document is received according to the access information (operation 1204). The received at least one background markup document is used as a background and a markup document including variable data is overlaid on the background, so that an integrated web page is displayed or printed (operation 1206).

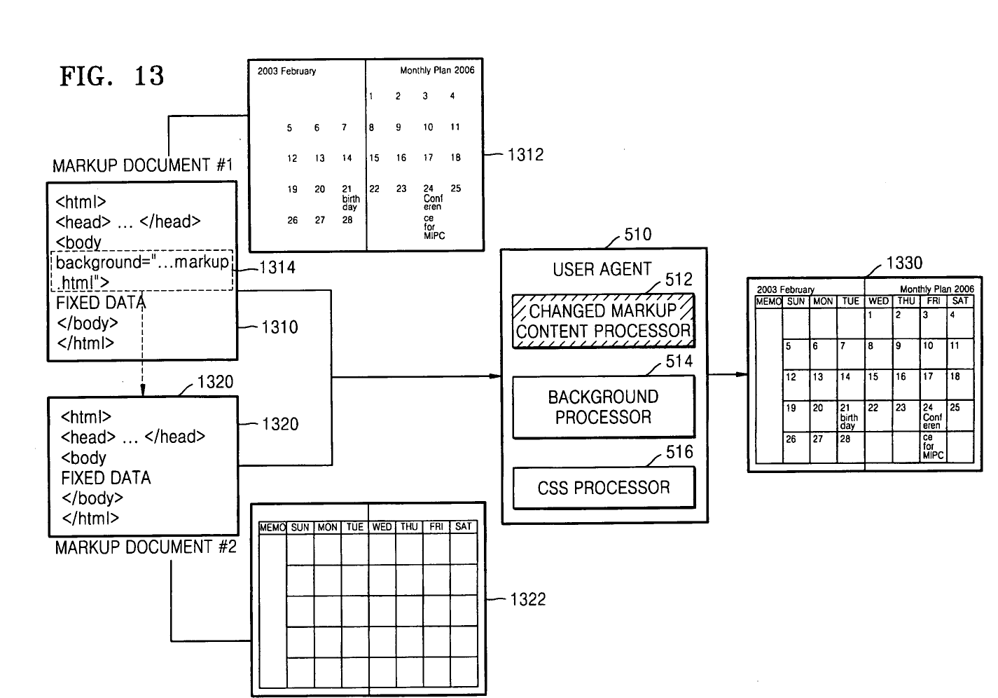

FIG. 13 illustrates an example to which the markup document processing method illustrated in FIG. 12 is applied.

Referring to FIG. 13, a markup document 1310 including variable data includes a path name 1314 for a background markup document 1320. The markup content processor 512 (see FIG. 5) uses a web page 1322 according to the background markup document 1320 as a background, and overlays a web page 1312 according to the markup document 1310 onto the background, thereby outputting an integrated web page 1330.

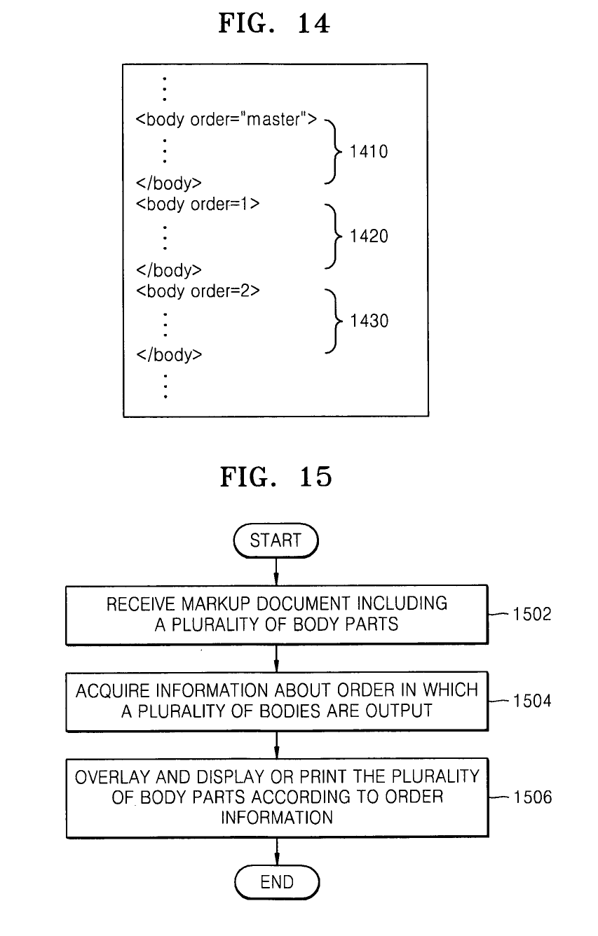

FIG. 14 is a view for explaining a computer-readable medium storing markup documents, according to another exemplary embodiment of the present invention.

Referring to FIG. 14, in order to output an integrated web page, a plurality of body parts 1410, 1420 and 1430 are included in a markup document. Information about an order in which the respective body parts 1410, 1420 and 1430 are output can be included in the markup document. In the current exemplary embodiment, information indicating a master body including fixed data, and information representing an overlay order or a print order of the remaining body parts are included in <body> tags of the respective body parts 1410, 1420, and 1430.

When display is performed, a web page according to a first body 1410 is placed as a background at the lowermost part, and a second body 1420 and a third body 1430 are sequentially overlaid on the background, so that an integrated web page is constructed. Likewise, when printing is performed, three body parts 1410, 1420 and 1430 are overlaid and thus a web page is printed. Alternatively, data included in the first body 1410 is constructed as a master page which becomes a background, and a web page created by overlaying the second body 1420 onto the background and a web page created by overlaying the third body 1430 thereon are sequentially printed.

FIG. 15 is a flowchart illustrating a markup document processing method according to an exemplary embodiment of the present invention. In the markup document processing method, the markup content processor 512 processes markup documents constructed as illustrated in FIG. 14.

Referring to FIG. 15, first, a markup document including a plurality of body parts is received (operation 1502). Then, the received markup document is interpreted and thus information about an order in which a plurality of bodies are output is obtained (operation 1504). If order information is not defined in the respective body parts or in any other part of the markup document, order information can be determined as an order in which the respective body parts are described. According to the determined order information, the plurality of body parts are overlaid and displayed or printed (operation 1506). As described above, according to an exemplary embodiment of the present invention, it is possible to print several web pages using a master body as a background.

The method according to an exemplary embodiment of the present invention as described above can be implemented by a computer readable code in a computer readable recording medium.

As described above, according to an exemplary embodiment of the present invention, by introducing a concept of an output order and a master page to a plurality of independent markup documents, it is possible to integrate and output the plurality of markup documents as a single page.

Also, by dividing a markup document into a template part and a content part and implementing them as independent markup documents, readability of documents is enhanced and efficient document processing and management is possible.

Also, it is possible to utilize an existing markup document as a document that is to be output as a background or as arbitrary data, without correction.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A computer-readable medium, comprising:
a plurality of markup documents; and
order information indicating an output order of the plurality of markup documents.

2. The computer-readable medium of claim 1, further comprising a start document including access information for the plurality of markup documents.

3. The computer-readable medium of claim 2, wherein the order information is recorded in the start document.

4. The computer-readable medium of claim 3, wherein the order information comprises information indicating that one of the plurality of markup documents is a master document comprising fixed data that is to be printed as a background of a different markup document.

5. The computer-readable medium of claim 4, wherein the order information further comprises information about an order in which the remaining markup documents except for the master document are overlaid and printed on the master document.

6. The computer-readable medium of claim 3, wherein the order information comprises information about an order in which the plurality of markup document are overlaid, when the plurality of markup documents are displayed as a web page.

7. The computer-readable medium of claim 1, wherein the order information is recorded in the plurality of markup documents.

8. The computer-readable medium of claim 7, wherein the order information comprises information indicating that a corresponding markup document is a master document including fixed data that is to be printed as a background of a different markup document, or information about an order in which the corresponding markup document is overlaid and printed on the master document.

9. The computer-readable medium of claim 7, wherein the order information comprises information about an order in which corresponding markup documents are overlaid, when the plurality of markup documents are displayed as a web page.

10. The computer-readable medium of claim 1, wherein one of the plurality of markup documents is a background markup document that is to be output as a background of a different markup document comprising variable data, and
the order information comprises access information for the background markup document, and the access information for the background markup document is recorded in the different markup document comprising the variable data.

11. The computer-readable medium of claim 10, further comprising at least one background markup document,
wherein the order information comprises information about an order in which the at least one background markup document is overlaid, when the plurality of markup documents are displayed.

12. The computer-readable medium of claim 11, wherein the order information about the order in which the at least one background markup documents is overlaid is recorded in the different markup document comprising the variable data.

13. The computer-readable medium of claim 11, wherein the order information about the order in which the at least one background markup document is overlaid is recorded in the at least one background markup document.

14. A computer-readable medium storing a markup document, the markup document comprising:
a plurality of body parts; and
order information about an order in which the plurality of body parts are output.

15. The computer-readable medium of claim 14, wherein the order information comprises information about a master body that is to be printed as a background of different body parts, when the markup document is printed.

16. The computer-readable medium of claim 15, wherein the order information further comprises information indicating an order in which the remaining body parts except for the master body are overlaid and printed on the master body.

17. The computer-readable medium of claim 14, wherein the order information further comprises information indicating an order in which the plurality of body parts are overlaid, when the markup document is displayed as a web page.

18. The computer-readable medium of claim 14, wherein the order information is recorded in the respective body parts.

19. A method of processing a markup document, comprising:
receiving a start document comprising access information for a plurality of markup documents;
acquiring order information indicating an order in which the plurality of markup documents are output;
receiving the plurality of markup documents according to the access information; and
outputting the plurality of markup documents according to the order information.

20. The method of claim 19, wherein the acquiring of the order information comprises interpreting the start document and determining the output order.

21. The method of claim 19, wherein the outputting of the plurality of markup documents comprises:
selecting one of the plurality of markup documents as a master document comprising fixed data, with reference to the order information; and
controlling so that the remaining markup documents except for the master document are respectively overlaid on the master document and sequentially printed according to the order information.

22. The method of claim 19, wherein the outputting of the plurality of markup documents comprises:
generating and outputting an image in which the plurality of markup documents are overlaid, according to the order information.

23. The method of claim 19, wherein the acquiring of the order information comprises interpreting the plurality of markup documents and determining the output order.

24. The method of claim 19, wherein the acquiring of the order information comprises determining the output order, according to a description order of access information recorded in the start document or according to an order in which the plurality of markup documents are received.

25. A method of processing a markup document, comprising:
receiving a markup document comprising variable data and access information for at least one background markup document;
receiving the at least one background markup document according to the access information;
overlaying the markup document comprising the variable data on the at least one background markup document; and
outputting the resulting overlaid markup document.

26. The method of claim 25, wherein the overlaying of the markup document further comprises determining an overlay order, with reference to information about an order in which the at least one background markup document is output.

27. The method of claim 26, wherein the determining of the overlay order comprises determining the overlay order according to order information included in the markup document comprising the variable data.

28. The method of claim 26, wherein the determining of the overlay order comprises determining the overlay order according to order information included in the at least one background markup document.

29. A method of processing and outputting a markup document, comprising:
receiving a markup document comprising a plurality of body parts;
acquiring order information about an output order in which the plurality of body parts are to be output; and
controlling so that the plurality of body parts are overlaid and displayed or printed according to the order information.

30. The method of claim 29, wherein the acquiring of the order information comprises interpreting the respective body parts and determining the output order.

31. The method of claim 29, wherein the acquiring of the order information comprises determining the output order according to an order in which the respective body parts are described in the markup document.

32. An apparatus comprising:
a processor which processes and outputs a markup document in order to display or print the markup document,
wherein the processor comprises a markup content processor which receives a start document comprising access information for a plurality of markup documents, acquires order information indicating an output order in which the plurality of markup documents are to be output, receives the plurality of markup documents according to the access information, and outputs the plurality of markup documents according to the order information.

33. The apparatus of claim 32, wherein the markup content processor interprets the start document and acquires the order information.

34. The apparatus of claim 32, wherein the markup content processor selects one of the plurality of markup documents as a master document comprising fixed data, with reference to the order information, and controls so that the remaining markup documents except for the master document are respectively overlaid on the master document and sequentially printed on a printer according to the order information.

35. The apparatus of claim 32, wherein the markup content processor generates an image in which the plurality of markup documents are overlaid according to the order information, and outputs the image to a display.

36. The apparatus of claim 32, wherein the markup content processor interprets the plurality of markup documents and acquires the order information.

37. The apparatus of claim 32, wherein the markup content processor determines the output order, according to a description order of access information recorded in the start document or according to an order in which the plurality of markup documents are received.

38. An apparatus comprising:
a processor which processes and outputs a markup document to display or print the markup document,
wherein the processor comprises a markup content processor which receives a markup document comprising variable data and access information of at least one background markup document, receives the at least one background markup document according to the access information, overlays the markup document comprising the variable data on the at least one background markup document, and outputs the resultant markup document.

39. The apparatus of claim 38, wherein the markup content processor determines an overlay order, with reference to order information indicating an order in which the at least one background markup document is to be output.

40. The apparatus of claim 39, wherein the markup content processor determines the overlay order according to order information included in the markup document comprising the variable data.

41. The apparatus of claim 39, wherein the markup content processor determines the overlay order according to order information included in the at least one background markup document.

42. An apparatus for processing and outputting a markup document to display or print the markup document, the apparatus comprising:
a markup content processor which receives a markup document comprising a plurality of body parts, acquires order information about an order in which the plurality of body parts are to be output, overlays the plurality of body parts according to the order information, and controls at least one of a display and printer so that the plurality of body parts are displayed on the display or printed on the printer.

43. The apparatus of claim 42, wherein the markup content processor interprets the respective body parts and acquires the order information.

44. The apparatus of claim 42, wherein the markup content processor determines the output order according to an order in which the respective body parts are described in the markup document.
